(19) United States
(12) Patent Application Publication
(10) Pub. No.: US 2026/0061539 A1
(43) Pub. Date: Mar. 5, 2026

(54) INTEGRATED SYSTEM FOR A COMPUTER-ASSISTED COILING MACHINE TOOL

(71) Applicants: John M. Tursky, Hillsborough, NJ (US); Harikrushna Patel, Secaucus, NJ (US)

(72) Inventors: John M. Tursky, Hillsborough, NJ (US); Harikrushna Patel, Secaucus, NJ (US)

(21) Appl. No.: 19/362,266

(22) Filed: Oct. 17, 2025

Related U.S. Application Data
(63) Continuation-in-part of application No. 18/825,696, filed on Sep. 5, 2024.

(51) Int. Cl. B23Q 15/12; G05B 13/02

(52) U.S. Cl. CPC B23Q 15/12; G05B 13/0265

(57) ABSTRACT

An integrated system for a computer-assisted coiling machine tool comprises a coiling machine 112 equipped with a coiling arbor 202 for gripping a workpiece, a support assembly 204 to support the workpiece, a force sensor sensing the force exerted by the workpiece, and a variable pitch adjusting unit 208 to alter the pitch of the coil to be formed. An AI-based control unit 100 is connected to the coiling machine 112 and includes a data collection module 104 that generates a force profile based on force sensor output. A machine learning module 106 compares the generated force profile with an expected force profile pre-stored in a database 110 and generates a predictive force profile. An adaptive control module 108 performs real-time adjustments to allow the control unit 100 to actuate the aforesaid components to implement incremental improvements and dynamic adjustments, thereby ensuring production of high-quality coiling products.

### CROSS REFERENCE TO RELATED APPLICATIONS

This application is a continuation in part of U.S. patent application Ser. No. 18/825,696, Sep. 5, 2024, which is hereby incorporated in its entirety by reference thereto.

### BACKGROUND OF THE INVENTION

### 1. Field of Invention

The present invention relates to the field of production industry, more specifically to an integrated system for a computer-assisted coiling machine tool that facilitates forming helical coils in an automated manner by integrating real-time force monitoring during coiling while eliminating manual intervention to ensure high accuracy, consistency, and efficiency during coiling.

### 2. Description of the Prior Art

Forming helical coils from metallic tubes, rods, and wires is essential in the HVAC, automotive, aerospace, and construction industries. Traditional coiling machines or systems feed workpieces through rotating arbors or mandrels while adjusting pitch and direction. However, these systems rely heavily on manual intervention, requiring operators to handle tasks such as clamping, adjusting pitch and torque, and visually monitoring the process. This dependency on human skill introduces variability and limits the consistency and repeatability of coil quality-particularly when material properties vary between batches.

The primary reason for the shortcomings of conventional coiling machines is the lack of real-time feedback mechanisms. These systems cannot detect or measure critical dynamic forces such as torque, stress, or strain during operation. As a result, misalignments, changes in tension, or material inconsistencies often go unnoticed until the process is complete—leading to defective coils, increased scrap, and production inefficiencies.

Moreover, controlling coil pitch and diameter becomes increasingly difficult when dealing with complex geometries, high-speed production, or diverse materials. Adjustments to pitch were usually fixed or manually performed, making real-time corrections nearly impossible. This lack of adaptability raises the labor costs, increases setup times, and limits production scalability.

Accordingly, there exists an unmet need for a system that integrates real-time force monitoring, automated adjustment of coiling parameters, real-time adaptability, and data-driven learning to ensure precision, consistency, and reduced manual oversight.

### OBJECTIVES OF THE INVENTION

The principal objective of the present invention is to overcome the limitations of the conventional arts:

An objective of the present invention is to develop a system that provides a means of self-correcting the deviations and errors that occur during the coiling operation, in real time.

Another objective of the present invention is to develop a system that minimizes human intervention, making the coiling operation less laborious and non-tedious.

Another objective of the present invention is to develop a system that facilitates adjusting or altering the dimension configuration of the workpiece to be formed, without requiring any manual intervention, thereby minimizing the events of errors and glitches that occur during the coiling operation.

A further objective of the present invention is to develop a system that allows real-time monitoring and adaptive control of coiling parameters such as pitch, feed rate, and rotational speed.

Yet another objective of the present invention is to develop a system that improves production efficiency and consistency in the coil formation.

The foregoing and other objects, features, and advantages of the present invention will become readily apparent upon further review of the following overview and description of the preferred embodiment as illustrated in the accompanying drawings.

### SUMMARY OF THE INVENTION

This section provides a general summary of the disclosure and is not a comprehensive disclosure of the full scope of all its features.

The present invention discloses an integrated system for a computer-assisted coiling machine tool that enables real-time, intelligent control of tube coiling operations to enhance product quality and consistency while detecting and minimizing errors during the coil operation.

According to an embodiment of the present invention, there is disclosed an integrated system for a computer-assisted coiling machine tool. The system comprises a computer numerical control (CNC) coiling machine equipped with a coiling arbor having a fixture clamp to grip and manipulate a workpiece, a support assembly with one or more rotating rollers to support the workpiece during the coiling operation, and a variable pitch adjusting unit for dynamically altering the coil pitch. A force sensor is integrated into the rotating rollers to detect real-time force exerted by the workpiece during the coiling process. The system includes an AI-based control unit operatively connected to the CNC machine and a central database. The AI-based control unit comprises a data collection module to convert sensor inputs into a time-series dataset and generate a corresponding force profile, a machine learning module to compare the generated force profile with expected profiles stored in the database to identify deviations and generate predictive profiles, and an adaptive control module configured to make real-time adjustments to the coiling arbor, support assembly, and pitch adjusting unit. These modules work in coordination to enable autonomous, data-driven control of the coiling operation for optimal product quality.

According to another embodiment, the central database stores a historical record of expected and predictive force profiles, enabling continuous learning and training to improve the coiling machine's accuracy.

In another embodiment, the coiling machine includes a base table that acts as the main structural support for the coiling arbor, the support assembly, and the variable pitch adjusting unit.

In another embodiment, the support assembly and the variable pitch adjusting unit are jointly secured onto the base table using linear guide rails mounted on the base table.

In another embodiment, the guide rails are driven by a threaded shaft connected to a first servomotor, providing a combined linear motion to the support assembly and variable pitch adjusting unit during coiling.

In one embodiment, the coiling arbor is mounted on the base table and positioned between an arbor support and a power transmission unit attached to the base table.

In one embodiment, the power transmission unit includes a second servomotor and a gearbox, which collaboratively actuate the coiling arbor at variable speeds and torques based on coiling parameters, including the number of turns, coil pitch, coil length, and coil diameter.

In another embodiment, the variable pitch adjusting unit includes a ball-screw driven by a third servomotor that tilts the support assembly in real-time to adjust the coil's pitch according to coiling parameters.

In one embodiment, the support assembly tilts about a pivoted section located within the joint arrangement of the support assembly and the pitch adjusting unit.

In a further embodiment, the workpiece being coiled is selected from a group that includes rigid or hollow shafts, rods, wires, pipes, and tubes.

In yet another embodiment, the machine learning module includes a default model selected from regression models, time-series forecasting models, or neural networks, which are trained to identify force profile data.

In one embodiment, the adaptive control module modifies the coiling arbor parameters, such as speed and torque, to match the predictive force profile.

In one embodiment, the force sensors collect data representing dynamic forces during coiling, such as pressure, stress, strain, or torque, to detect force variations that influence product quality.

In a further embodiment, the control unit features a user interface for receiving input parameters for manufacturing coiling products.

According to another aspect of the present invention, there is disclosed a method for performing a coiling operation using a computer-assisted coiling machine tool. The method comprises the first step of clamping a workpiece in the machine using a coiling arbor and supporting it with a support assembly to initiate the coiling process. During coiling, a force sensor embedded within the support assembly continuously detects the real-time force exerted by the workpiece. This force data is converted into a time-series dataset to generate a corresponding force profile. A machine learning module starts comparing the generated force profile with an expected force profile retrieved from a central database to detect deviations, based on which a predictive force profile is generated. Using this predictive profile, the control unit, via an adaptive control module, starts performing real-time adjustments by actuating the coiling arbor, support assembly, and variable pitch adjusting unit. These adaptive modifications, which ensure incremental improvements in the coiling process, are implemented during production of a part, thereby enabling the production of high-quality, precision coils with minimal manual intervention.

### BRIEF DESCRIPTION OF THE DRAWINGS

The invention will be fully understood, and further advantages will become apparent when reference is had to the following detailed description of the preferred embodiments of the invention and the accompanying drawings in which:

FIG. 1 illustrates a schematic view of an integrated system for a computer-assisted coiling machine tool, in accordance with an embodiment of the present invention.

FIG. 2A illustrates a perspective view of the coiling machine of FIG. 1, in accordance with an embodiment of the present invention.

FIG. 2B illustrates a top view of the coiling machine of FIG. 1, in accordance with an embodiment of the present invention.

FIG. 2C illustrates a top view of the coiling machine of FIG. 1 in a variable pitch adjustment stage, in accordance with an embodiment of the present invention.

FIG. 3 illustrates a flow diagram explaining a method of performing a coiling operation in a computer-assisted coiling machine of FIG. 1, in accordance with an embodiment of the present invention.

### DETAILED DESCRIPTION OF THE INVENTION

The embodiments herein and the various features and advantageous details thereof are explained more fully with reference to the non-limiting embodiments that are illustrated in the accompanying drawings and the following description. Numerous variations, changes, and substitutions may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms used in the application, as all equivalents, synonyms, new developments, and terms or techniques that serve the same or a similar purpose are considered to be within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

As used herein, the term “or” includes “and/or” and the term “and/or” includes any and all combinations of one or more of the associated listed items. Expressions such as “at least one of” when preceding a list of elements modify the entire list of elements and do not modify the individual elements of the list.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present invention relates to an integrated, computer-assisted coiling system that performs real-time detection and correction of deviations during the coiling process by utilizing automated sensing and adaptive control mechanisms while eliminating the need for manual adjustments, thereby reducing manual human intervention and minimizing human error.

Additionally, the system enables automatic, real-time adjustment of key parameters such as pitch, feed rate, and rotational speed during production of a part, ensuring precise coil formation, consistent quality, and enhanced productivity across varying workpiece dimensions.

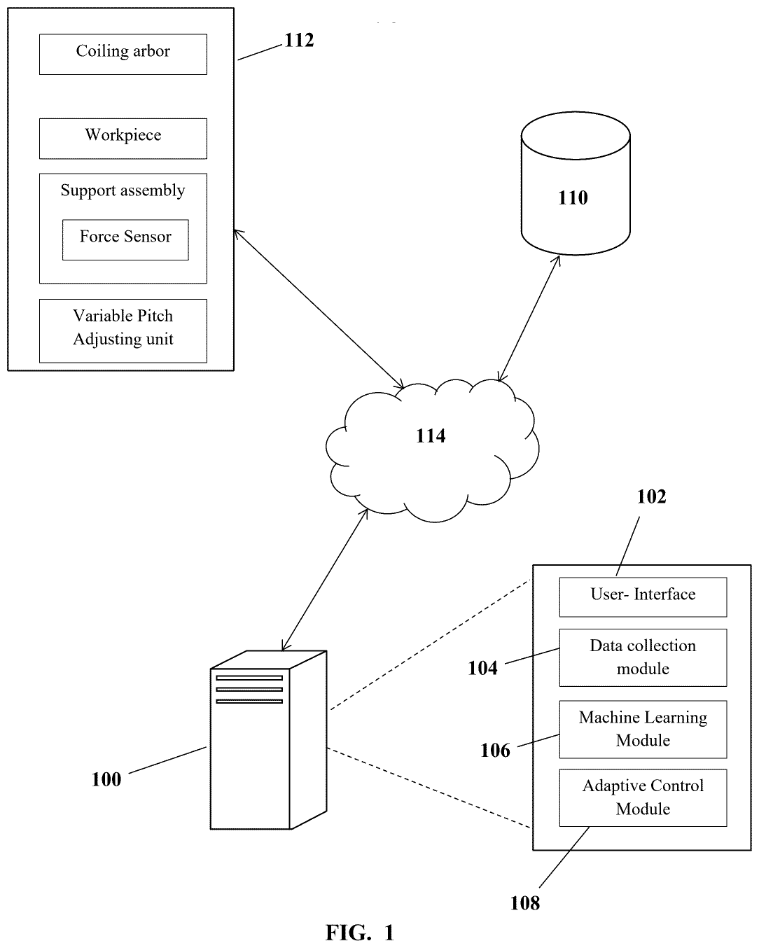

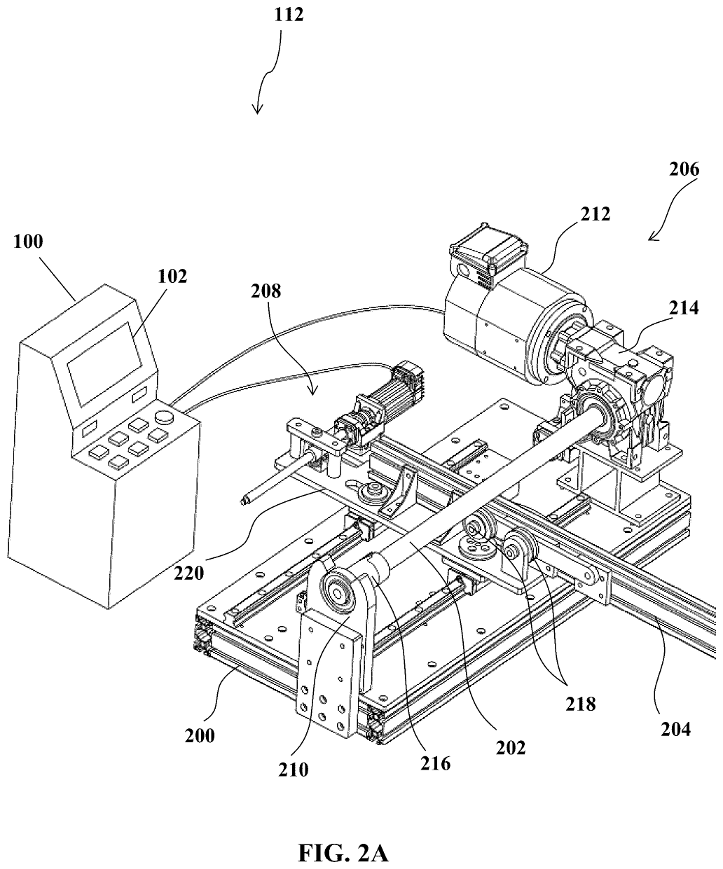

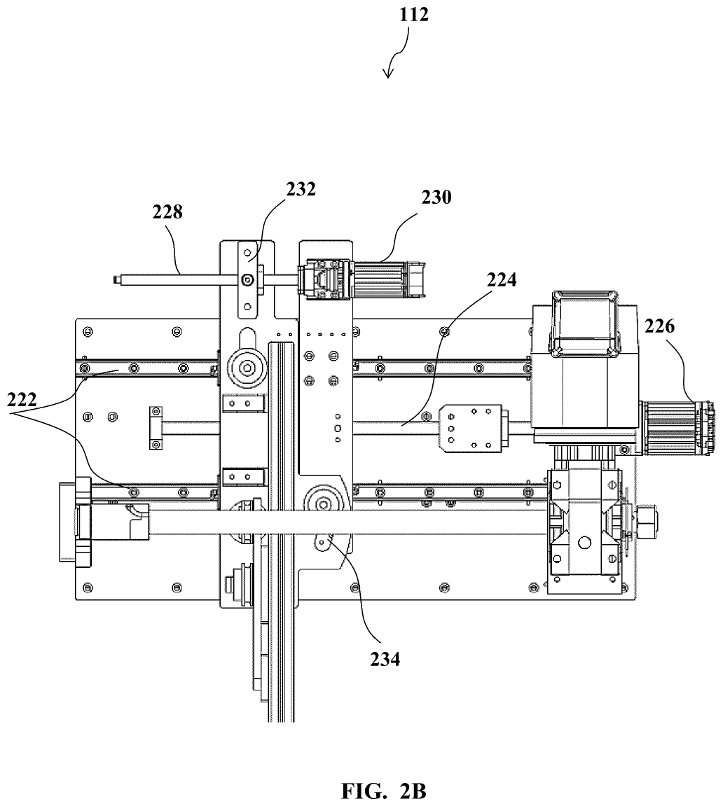

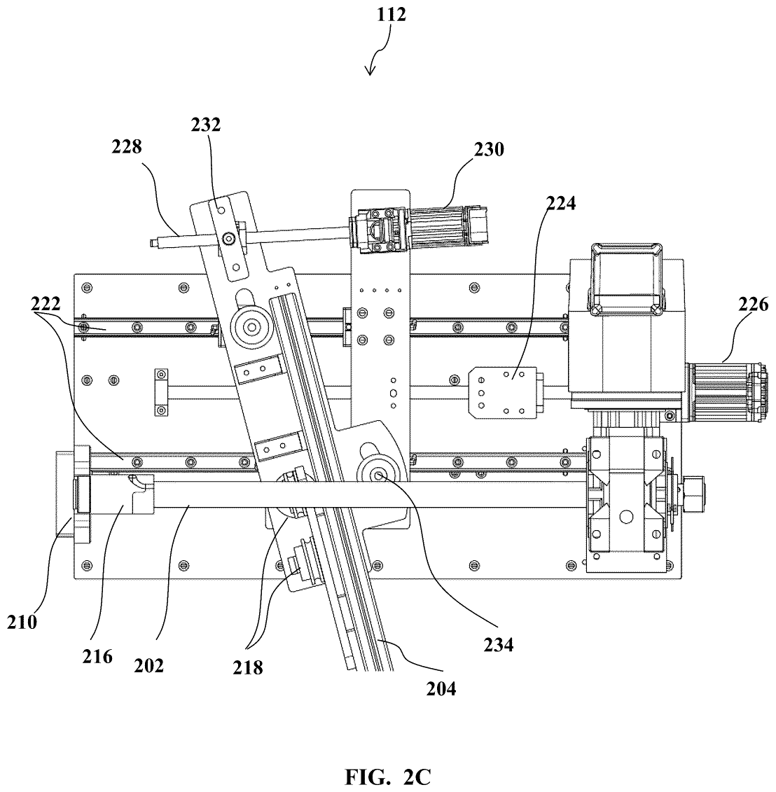

Referring to FIG. 1, there is depicted a schematic view of an integrated system for a computer-assisted coiling machine tool. The system indicates a control unit 100 operatively connected with a CNC coiling machine 112 having a coiling arbor, a support assembly with a force sensor, and a variable pitch adjusting unit (shown in FIGS. 2A-2C). The control unit 100 comprises a user-interface 102 and includes a Data collection module 104, a machine learning module 106, and an adaptive control module 108 to process the outputs of the aforementioned components. A central database 110 is linked via a communication network 114 to the control unit 100 of the coiling machine 112 for data transmission between the control unit 100 and the central database 110. Said communication network 114 comprises interconnected nodes that exchange data using wired or wireless links. The network 114 is configured to transmit information between devices, servers, and user terminals. Data routing and control are managed through network protocols and communication standards. The network 114 may include local, wide-area, or cloud-based infrastructure to support scalable connectivity. All of these components function collaboratively to perform the coiling operation via the coiling machine 200. The detailed functioning and working operation of each of the aforesaid components is described in FIGS. 2A-2C.

FIGS. 2A and 2B illustrate a perspective view and a top view of a CNC coiling machine. Machine 112 is configured for precision winding and coiling of different work pieces such as wires, strips, tubes, rods, etc. The machine 112 primarily comprises a base table 200 upon which a coiling arbor 202, a support assembly 204, a power transmission unit 206, and a variable pitch adjusting unit 208 are mounted. A control unit 100 equipped with a user-interface 102 is operatively connected with the coiling machine 200 to operate and control the functioning of all the components during the coiling process. These components work collaboratively to perform the coiling operation on various workpieces, including rigid or hollow shafts, rods, wires, pipes, and tubes.

The base table 200 disclosed above serves as the core structure of the machine 200 and is in a cuboidal shape orientation having a relative thickness. The base table 200 provides ample space for the functioning of the said component. The base table 200 is fabricated from a robust material selected from a group including cast iron, structural-grade steel, and the like, which offers high stiffness, vibration damping, and dimensional stability. Such robust construction of the base table 200 provides a core foundation to bear dynamic loads and maintain alignment accuracy throughout the coiling operation.

On the base table 200, the coiling arbor 202 is mounted, which holds and rotates the workpiece for preparing the coil products. The coiling arbor 202 is an elongated shaft-like entity composed of hardened alloy steel and has a high torsional strength and resistance to fatigue during continuous rotation. One end of the coiling arbor 202 is secured within an arbor support 210 attached to the base table 200, while the other end is coupled to the power transmission unit 206. Such a configuration allows the coiling arbor 202 to extend horizontally between the arbor support 210 and the power transmission unit 206, to keep it aligned along an axis on which the coiling process is to be carried out on the workpiece. The arbor support 210 herein refers to an inverted U-shaped element that supports one end of the coiling arbor 202 via a ball bearing (not shown) installed in the arbor support 210. The ball bearing aids in a smooth and continuous rotation of the coiling arbor 202 upon actuation via the power transmission unit 206, during the coiling operation.

The power transmission unit 206 disclosed here includes a second servomotor 212 and a gearbox 214, coupled to the coiling arbor 202 for rotating the coiling arbor 202 and the workpiece during the coiling operation. In an embodiment, the gearbox 214 comprises a helical or planetary gear arrangement driven by the second servo motor 212. This configuration is primarily responsible for adjusting the speed and torque of the coiling arbor 202 as per the coiling parameters, which include the number of turns, pitch of coil, length of coil, and diametric dimensions of coil.

In a preferred embodiment, the gearbox 214 is coupled directly to the coiling arbor 202, ensuring efficient power transfer and precise motion control to perform coiling in accordance with the diverse material and process requirements.

Further, the coiling arbor 202 includes a fixture clamp 216, which allows affixing of the workpiece on the coiling arbor 202 to perform the coiling operation. The fixture clamp 216 is positioned at the end, proximal to the arbor support 210, of the coiling arbor 202. The fixture clamp 216 includes a circumferential slot for securely gripping the workpiece over the coiling arbor 202.

In proximity to the coiling arbor 202, the support assembly 204 is mounted on the base table 200 to support the workpiece. The support assembly 204 includes one or more free-rotating rollers 218, which support and stabilize the workpiece during the coiling operation. The one or more free rotating rollers 218 are fabricated from wear-resistant materials such as hardened steel or polyurethane-coated alloys, depending on the surface finish requirements of the coiled product to be made. Also, these rotating rollers 218 offer high vibration damping and dimensional stability.

In these, one or more rotating rollers 218 have a groove fabricated, which is configured to engage with the circumferential surface of the workpiece for providing a continuous stability to the workpiece during rotation. This, in turn, eliminates the events of misalignment of the workpiece during the coiling process.

Further, a force sensor is also embedded in the support assembly 204 to detect the force exerted by the workpiece during the coiling process. The force sensor is positioned at a point of contact between the workpiece and the rotating rollers 218 to determine the force exerted by the workpiece on the rollers 218 in real time. In an embodiment, the force sensor detects the force in terms of torque or pressure in pounds per square inch (PSI).

In another embodiment, the force sensor captures the data indicative of dynamic forces involved during coiling, which includes pressure, stress, strain, or torque, thereby determining force variations affecting the quality of the coiling product.

Furthermore, the coiling machine 200 includes the variable pitch adjusting unit 208 mounted on the base table 200 in collaboration with the support assembly 204. The variable pitch adjusting unit 208 and the support assembly 204 are arranged together on a movable platform 220 equipped on the base table 200 via a set of linear guide rails 222. These guide rails 222 are fastened over the base table 200 in a parallel orientation to provide a collaborative linear motion to both the pitch adjusting unit 208 and support assembly 204 during the coiling process. In an embodiment, the guide rails 222 are operated via a threaded shaft 224 coupled with a first servomotor 226 for providing a combined linear motion to the support assembly 204 and variable pitch adjusting unit 208 during the coiling process.

The aforesaid variable pitch adjusting unit 208 includes a ball-screw 228 and a third servomotor 230 coupled together and configured to change the pitch dimensions of the coil being made. The ball-screw 228 of the pitch adjusting unit 208 is arranged in such a manner that one end of the ball-screw 228 is coupled with the third servomotor 230. Meanwhile, the other end of the ball-screw 228 is secured in a ball-nut housing 232 and is equipped on the support assembly 204. The ball-nut housing 232 allows the ball-screw to threadingly engage with the support assembly 204 to tilt the support assembly 204 about a pivoted section 234 (as shown in FIG. 2B) in the movable platform 220, in real time.

Thereby changing the pitch dimension of the coil based on the coiling parameters. This, in turn, alters the direction of the free rotating rollers 218 to ensure continuous contact with the workpiece, which reduces wear, vibrations, or deflection during coiling operation. Thus, maintaining the geometric dimensions of the workpiece, in accordance with the changes in geometry, material, hardness, etc., of the workpiece during its formation.

Further, the coiling machine 200 comprises an AI-based control unit 100 that is primarily responsible for actuating and controlling the operation of the aforementioned components based on the inputs of a user received via an integrated user-interface 102 and real-time data determined from the output of said components. The control unit 100 includes several specialized modules that work collaboratively to process inputs from the components and optimize the machine's performance. In an embodiment, the user interface 102 disclosed herein is a display panel equipped with one or more push buttons that allow the user to input specific parameters related to the coiling products to be manufactured. The coiling parameters include the number of turns, pitch of coil, length of coil, coil material, and the diametric dimensions of the coil.

Once the user inputs the parameters and the cooling process initiates, a data collection module 104 integrated in the control unit 100 receives the user's inputs and the real-time data from the force sensor. Upon receiving the data, the data collection module 104 converts the received data from the force sensor to a time-series data set and generates a force profile based on the force exerted by the workpiece for each coil. The converted data is then analyzed by a machine learning module 106, which uses AI algorithms to continuously compare the converted force sensor data with an expected force profile that is stored within a central database 110 communicably linked with the control unit 100. This comparison continues during the production of a workpiece to adjust parameters and ensure the production of a perfect part.

In an embodiment, the central database 110 maintains a historical log of expected force profiles and predictive force profiles for continuous learning and training to enhance the accuracy of the coiling machine 100.

In another embodiment, the machine learning module 106 selects a default model from a group consisting of regression models, time-series forecasting models, and neural networks, and is trained to recognize patterns in the force profile data.

The machine learning module 106, during the comparison, performs sorting and bifurcation of the data of the generated force profile to identify any deviation or any error in the generated force profile in comparison to the stored expected force profile. Once the comparison is done, the machine learning module 106 generates a predictive force profile, which represents a required force path to maintain the target quality standard. The comparison is carried out many times, in microseconds, during the production of a workpiece to effect adjustments required to maintain the target quality standard.

As a required force path is indicated, an adaptive control module 108 embedded within the control unit 100 adjusts the parameters of the coiling arbor 202, in real time, including speed, feed rate, pitch angle, and torque, to replicate the predictive force profile, during the coiling operation. The adaptive control module 108 actuates the support assembly 204 and the variable pitch adjusting unit 208 based on the generated force profile. Therefore, by utilizing the output from the adaptive control module 108, the control unit 100 actuates the above-mentioned components to implement real-time incremental improvements and dynamic adjustments throughout the coiling process, if any deviation is detected. This allows the coiling machine 200 to take self-corrective measures and adjustments during production of a workpiece to ensure consistent coil quality for producing the optimal quality coiling products.

Referring to FIG. 2C, a top view of the CNC oiling machine 200 is illustrated, depicting the variable pitch adjustment unit 208 performing the variable pitching on the workpiece during the coiling operation. The operational working of the coiling machine 112 during pitch adjustment is described clearly in FIGS. 2A and 2 B.

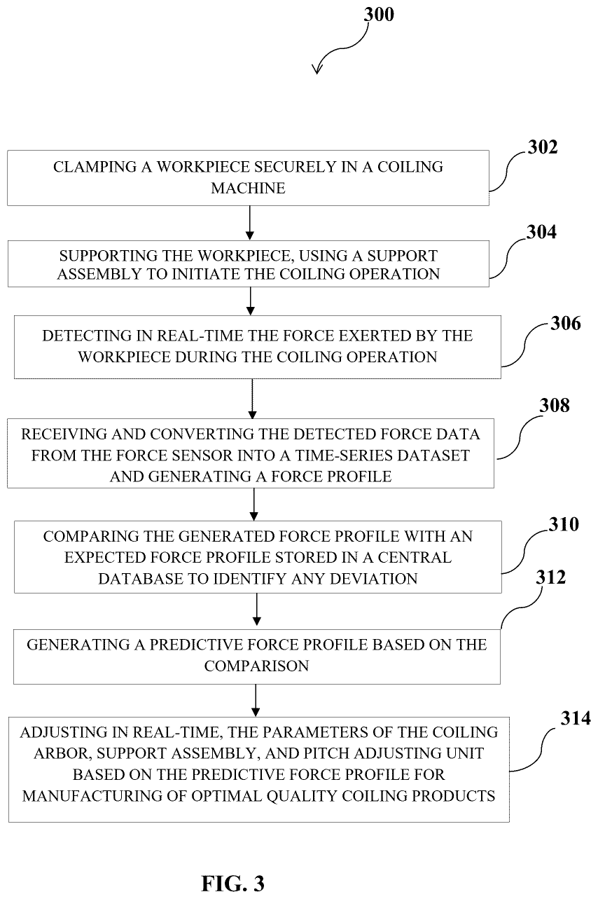

Referring to FIG. 3, there is illustrated a flow diagram explaining a method of performing a coiling operation in a computer-assisted coiling machine. Said method 300 begins with the first step 302 of clamping the workpiece securely in the coiling machine 112 using a coiling arbor 202. Optionally, the method includes configuring the coiling machine 112 by inputting various coiling parameters via a user interface upon clamping of the workpiece. These parameters include the number of coil turns, coil pitch, coil length, material type and properties, such as hardness, ductility, etc., and the diametric dimensions of the coil. Additionally, the user defines the kinds of movement to be imparted to the workpiece, selecting from linear motion, rotary motion, or a combination of both, depending on the desired coiling profile.

Once the clamping is done, the next step 304 involves supporting the workpiece using a support assembly 204 to initiate the coiling operation by actuating the power transmission unit 206. This rotates the coiling arbor 202 for coiling of the workpiece (a tube) into a helical shape, as a pre-bend tube is first clamped into a coiling arbor 202 with the support assembly 204. During the actuation of the coiling arbor 202, the control unit 100 actuates a threaded shaft 224 coupled with a first servomotor 226 to move the support assembly 204 in a linear motion toward the gearbox 214, creating the desired pitch for the helical coil.

During the coiling, the control unit 100, via a force sensor integrated in support assembly 204, starts the next step 306 of detecting, in real-time, the force exerted by the workpiece during the process. Following this force detection, the next step 308 is receiving and converting the sensed data into a time-series dataset via a data collection module 104, which then generates a force profile. Upon generation of the force profile, the next step 310 is comparing the generated force profile against an expected force profile, stored within a central database 110 using a machine learning module 106. This helps identify deviations from the ideal coiling conditions, and the next step, 312, is generating a predictive force profile, based on such deviations (if found during the comparison).

Based on this predictive force profile, an adaptive control module 106 embedded in the control unit 100 performs the next step 314 that is real-time adjustment of the coiling arbor 202 parameters along with the support assembly 204 and the variable pitch adjusting unit 208, based on the predictive force profile for incremental improvements to enable manufacturing of optimal quality coiling products.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the understanding that the phraseology or the terminology employed herein is for description and not for limitation. Therefore, while the embodiments herein have been described in terms of preferred embodiments, those skilled in the art will recognize that the embodiments herein can be practiced with modification within the spirit and scope of the appended claims.

The advantages set forth above, and those made apparent from the foregoing description, are efficiently attained. Since certain changes may be made in the above construction without departing from the scope of the invention, it is intended that all matters contained in the foregoing description be interpreted as illustrative and not in a limiting sense.

It is also to be understood that the following claims are intended to cover all the generic and specific features of the invention herein described, and all statements of the scope of the invention that, as a matter of language, might fall therewithin.

Having thus described the invention in rather full detail, it will be understood that such detail need not be strictly adhered to but that further changes and modifications may suggest themselves to one skilled in the art, all falling within the scope of the invention as defined by the subjoined claims.

I/We claim:

1. An integrated system for a computer-assisted coiling machine tool, the system comprising:
a computer numerical control (CNC) coiling machine (102) including:
a coiling arbor having a fixture clamp to grip and manipulate a workpiece for a coiling operation;
a support assembly having one or more rotating rollers for supporting the workpiece during the coiling operation;
a force sensor integrated in the rotating rollers to detect the real-time force exerted by the workpiece during coiling, and
a variable pitch adjusting unit configured with the machine for altering the pitch of the coil being formed during coiling;
an AI-based control unit operatively connected, via a communication network, with the coiling machine and a central database, wherein the AI-based control unit comprises:
a data collection module for converting inputs of force sensor into a time-series dataset and generating a force profile, based on the exerted force, for each coil during coiling operation;
a machine learning module for comparing the generated time-series force profile with an expected force profile stored in the central database to identify any deviation and generate a predictive force profile, based on the comparison of the generated profile and expected profiles; and
an adaptive control module for real-time adjustment of the parameters of the coiling arbor, support assembly, and the pitch adjusting unit based on the generated force profile,
wherein the AI-based control unit actuates the coiling arbor, the variable pitch adjusting unit, and the support assembly based on the output of the adaptive control module to make incremental improvements and dynamic adjustments to produce optimal quality coiling products.

2. The system of claim 1, wherein the central database is configured to maintain a historical log of expected force profiles and predictive force profiles for continuous learning and training to enhance the accuracy of the coiling machine.

3. The system of claim 1, wherein the coiling machine comprises a base table that serves as a core structure to support the coiling arbor, support assembly, and the variable pitch adjusting unit.

4. The system of claim 3, wherein the support assembly and the variable pitch adjusting unit are secured collaboratively over the base table via a set of linear guide rails affixed on the base table.

5. The system of claim 4, wherein the guide rails are actuated via an actuation mechanism which includes a guiding screw coupled with a first servomotor for providing a combined linear motion to the support assembly and variable pitch adjusting unit during the coiling process.

6. The system of claim 1, wherein the coiling arbor is mounted over the base table between an arbor support and a power transmission unit affixed to the base table.

7. The system of claim 6, wherein the power transmission unit includes a second servomotor and a gearbox to rotate the coiling arbor at variable speed and torque as per the coiling parameters, including pitch of coil, length of coil, coil material hardness and ductility, and diametric dimensions of coil.

8. The system of claim 7, wherein the variable pitch adjusting unit comprises a ball-screw coupled with a third servomotor for tilting the support assembly, in real time, according to the incremental improvements and dynamic adjustments performed based upon the coiling parameters.

9. The system of claim 7, wherein the support assembly tilts about a pivoted section provided in the collaborative arrangement of the support assembly and the pitch adjusting unit.

10. The system of claim 1, wherein the work piece is selected from a group including rigid or hollow shafts, rods, wires, pipes, and tubes.

11. The system of claim 1, wherein the machine learning module includes a default model selected from a group consisting of regression models, time-series forecasting models, and neural networks, and is trained to recognize patterns in the force profile data.

12. The system of claim 1, wherein the adaptive control module adjustment of the coiling arbor parameters is selected from speed, torque, and specific movement patterns to replicate the predictive force profile.

13. The system of claim 1, wherein the force sensor's capture of data indicative of dynamic forces involved during coiling is selected from pressure, stress, strain, or torque, thereby determining force variations affecting the quality of the coiling product.

14. The system of claim 1, wherein the control unit includes a user interface for receiving parameters of coiling products to be manufactured.

15. A method of performing a coiling operation in a computer-assisted coiling machine tool, the method comprising:
clamping a workpiece in the coiling machine using a coiling arbor;
supporting the workpiece using a support assembly to initiate the coiling operation;
detecting in real-time, using a force sensor, the force exerted by the workpiece during the coiling operation;
receiving and converting the detected force data from the force sensor into a time-series dataset, and generating a force profile;
comparing, using a machine learning module, the generated force profile with an expected force profile stored in a central database to identify any deviation;
generating a predictive force profile based on the comparison; and
adjusting in real-time, the parameters of the coiling arbor, support assembly, and pitch adjusting unit based on the predictive force profile for incremental improvements to enable manufacturing of optimal quality coiling products.

16. The method of claim 15, wherein the clamping step further comprises adjusting the coiling machine based on various coiling parameters received from a user, via a user interface, to provide movements to the workpiece.

17. The method of claim 16, wherein the movements are selected from linear, rotary, or a combination thereof.

18. The method of claim 16, wherein the coiling parameters include the number of turns of coil, the pitch of coil, the length of coil, and the diametric dimensions of coil.
